(19) United States
(12) Patent Application Publication
(10) Pub. No.: US 2008/0030462 A1
(43) Pub. Date: Feb. 7, 2008

(54) Interactive music interface for music production

(76) Inventor: Erik M. Lasar, Montrose, CA (US)

Correspondence Address: BLANK ROME LLP, 600 NEW HAMPSHIRE AVENUE, N.W., WASHINGTON, DC, 20037, US

(21) Appl. No.: 11/878,435

(22) Filed: Jul. 24, 2007

Related U.S. Application Data
(60) Provisional application No. 60/832,614, filed on Jul. 24, 2006.

(51) Int. Cl. G09G 5/00

(52) U.S. Cl. 345/156

(57) ABSTRACT

A system for composing music provides the user with a user interface allowing the user to select music clips. The clips can include intros, loops, and ends, and the user can be allowed to search them by theme. The invention can be implemented on a standalone computer or over the Internet or other network.

### REFERENCE TO RELATED APPLICATION

The present application claims the benefit of U.S. Provisional Patent Application No. 60/832,614, filed Jul. 24, 2006, whose disclosure is hereby incorporated by reference in its entirety into the present application.

### FIELD OF THE INVENTION

The present invention is directed generally to a modular interactive music interface for electronic game developers, sound and video editors. In particular embodiments, the interface enables mixing and matching intro, loop and end music modules to create almost limitless versions of different seamless musical themes within the same composition.

### DESCRIPTION OF RELATED ART

Good music is important to many media, including games and advertising. Nonetheless, the people skilled in those media may not also be skilled in composing. Also, the cost of having music specially composed or of licensing music may be prohibitive.

### SUMMARY OF THE INVENTION

It is thus an object of the invention to provide an easy way for people not skilled in music composition to create music easily.

To achieve the above and other objects, the present invention is directed to a system and method that provide a user with a user interface allowing the user to select music clips. The clips can include intros, loops, and ends, and the user can be allowed to search them by theme. The invention can be implemented on a standalone computer or over the Internet or other network.

Other modifications that can be added to the invention include the following: seamless audio 2 track (stereo) editing, re-assembly, replacing and shuffling system; audio clip sorting on the fly (real-time); audio clip switching; various Intro-Loop-End types of audio clips; overall method of using seamless audio clips to structure a final song product; and the ability to export audio clip sequences in various types.

### BRIEF DESCRIPTION OF THE DRAWINGS

The accompanying drawings, which are incorporated herein and form a part of the specification, illustrate various exemplary embodiments of the present invention and, together with the description, further serve to explain various principles and to enable a person skilled in the pertinent art to make and use the invention.

FIG. 1 is an example screen shot from a software program according to an example embodiment of the invention;

FIG. 2 is a screen shot of a timeline display showing operation of the example software program;

FIG. 3 is a screen shot of a playback display showing playback operation of the example software program; and

FIG. 4 is a block schematic diagram showing an example embodiment of a general purpose computer system that can be used in implementing the invention.

FIG. 5 is an example screen shot of a user interface based on those of FIGS. 1-3.

FIGS. 6A-6F show music clips to explain a process for composing such clips to ensure smooth transitions.

### DETAILED DESCRIPTION OF THE PREFERRED EMBODIMENT

The present invention will be described in terms of one or more examples, with reference to the accompanying drawings. In the drawings, some like reference numbers indicate identical or functionally similar elements. Additionally, the left-most digit(s) of most reference numbers may identify the drawing in which the reference numbers first appear.

The present invention will be explained in terms of exemplary embodiments. This specification discloses one or more embodiments that incorporate the features of this invention. The disclosure herein will provide examples of embodiments, including examples of data analysis from which those skilled in the art will appreciate various novel approaches and features developed by the inventors. These various novel approaches and features, as they may appear herein, may be used individually, or in combination with each other as desired.

In particular, the embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, persons skilled in the art may effect such feature, structure, or characteristic in connection with other embodiments whether or not explicitly described.

Embodiments of the invention may be implemented in hardware, firmware, software, or any combination thereof, or may be implemented without automated computing equipment. Embodiments of the invention may also be implemented as instructions stored on a machine-readable medium, which may be read and executed by one or more processors. A machine-readable medium may include any mechanism for storing or transmitting information in a form readable by a machine (e.g. a computing device). For example, a machine-readable medium may include read only memory (ROM); random access memory (RAM); hardware memory in PDAs, mobile telephones, portable game devices, and other portable devices; magnetic disk storage media; optical storage media; flash memory devices; electrical, optical, acoustical, or other forms of propagated signals (e.g. carrier waves, infrared signals, digital signals, analog signals, etc.), and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

Good music is important in many types of media. The present invention features complete musical compositions that have been carefully crafted to work both as stand-alone tracks and as seamless modular compositions. The present invention has the potential to raise the bar for the level of quality and diversity of music available in multiple types of media, including games, advertising commercials, film and commercial music.

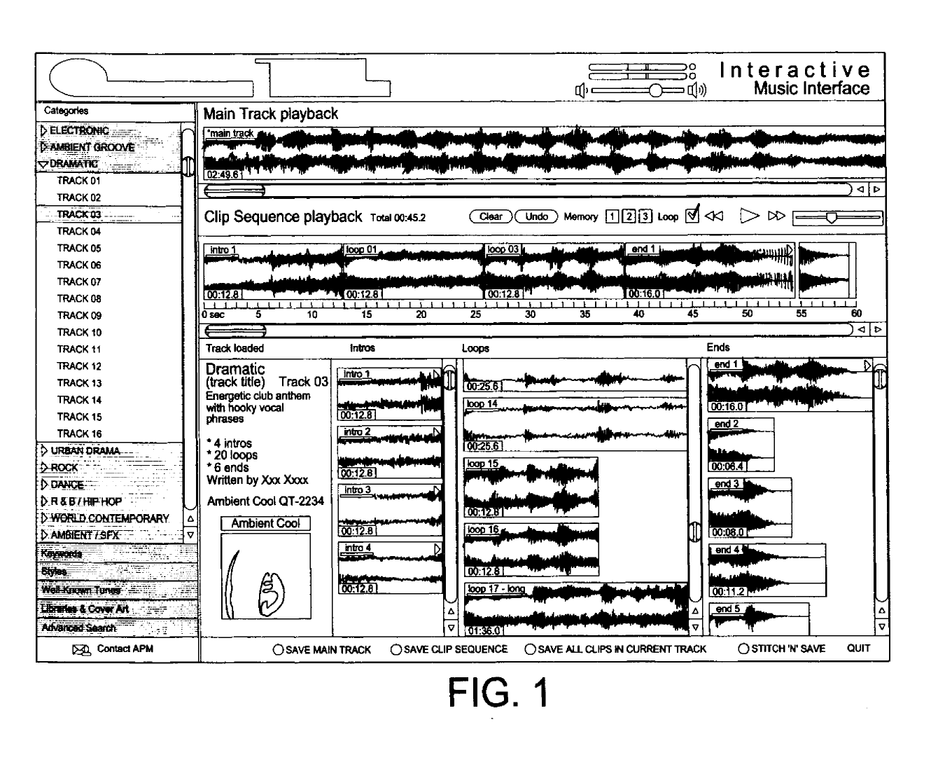

Exemplary embodiments of the present invention are illustrated in FIGS. 1-3. FIG. 1 illustrates the overall visualization of the present invention presented to a user. The left most section of the screen provides a search system with extended features to enhance the ability of the user to rapidly locate the type of sound he or she wishes to use. Tracks can be searched by categories, key word, style, well-known tunes, and/or cover art. Such information can be stored in searchable form in any suitable way, e.g., metadata. A scrolling list of music may be displayed, as shown in the “categories” list, to provide a list of available tracks under each search option. In this manner, the desired style of the performed track can be rapidly located and selected. The music clips displayed as available may be stored locally or in a server or library accessible through a network, such as the internet.

The top window provides an illustration of the main track playback and the clip sequence playback below that window. The clip sequence is made up of preformed seamless audio clips, where those seamless audio clips may be selected from the window below.

The window below the clip sequence playback window illustrates available seamless audio clips, broken down into three categories: intros, loops and ends. When an audio clip is selected, information about audio clip can be supplied. The information for the loaded track, in FIG. 1, “TRACK 3,” is provided in a portion of the lowest window. By viewing all of the audio clips together, it is easy for the user to mix and match to achieve a desired clip sequence. The timing of the sequences, or tempo, can be changes and certain tracks may be retained in memory for ease of reuse. The interface also provides a slider for volume and indicators to illustrate the relative strength of the stereo channels.

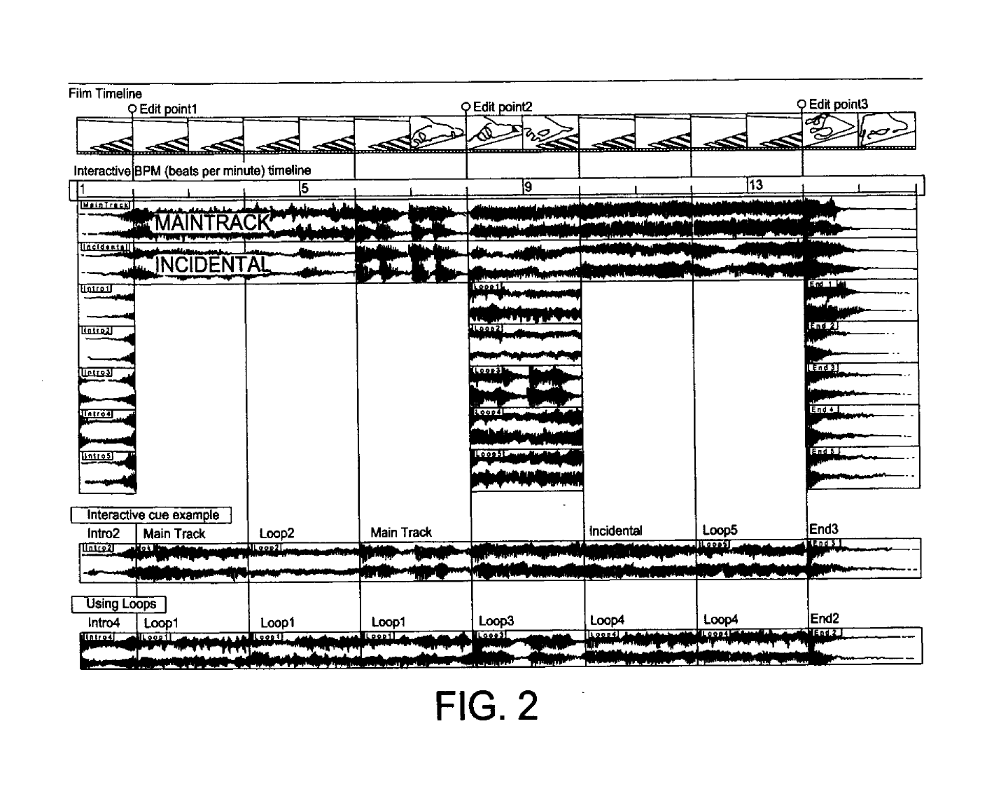

FIG. 2 illustrates the application of the present invention to provide scoring of a film or video sequence. The top timeline is a film timeline showing frames or set numbers of frames of the film or video. The interactive BPM (beats per minute) timeline provides a guide for the maintrack and incidental tracks and facilitates the positioning of the edit points. At the edit points, other intros, loops and/or endings may be snapped into place, as illustrated in the figure. The selection of alternate clip sequences automatically provides for alignments with the clip sequence just prior so that smooth transition points may be achieved. FIG. 2 also provides two examples toward the bottom of the figure, with the first being an interactive cue example and the second an example of the use of loops. The synchronization that can be achieved with the film and/or video can speed up the overall process of scoring such a sequence.

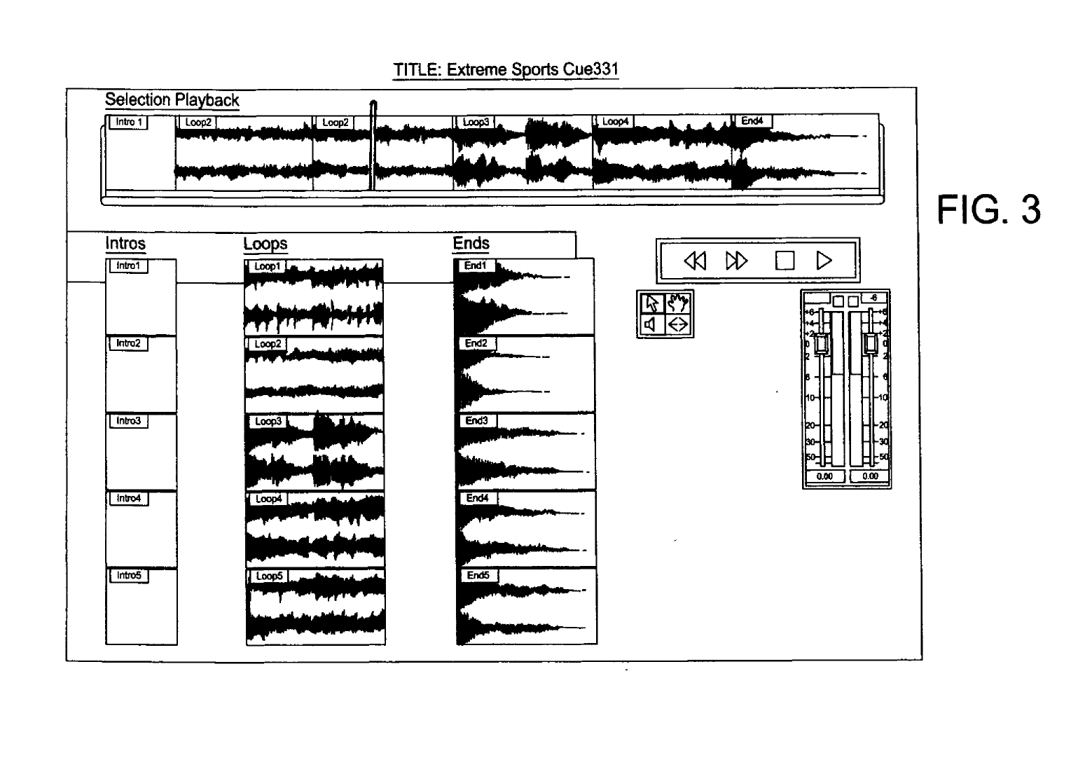

A more detailed examination of the window from FIG. 1 is provided in FIG. 3. An extreme sports cue is illustrated with possible intros, loops and ends. The selection playback illustrates the clip sequence being constructed, with the progress bar indicating a position within that clip sequence. Each of the intros, loops and ends can be played independent of the selection playback. The floating palette allows for manipulation of the clip sequences and a dual slider allows for the relative gains of the stereo channels to be adjusted.

In a preferred embodiment, the system works with tracks for use in film, television, radio, advertising and new media production assembled in a seamless modular music library. This library allows audio and video editors, game developers, etc., to use music modules of varying styles and intensities to create customized seamless scores.

In preferred embodiments, the system is both Mac and Microsoft Windows compatible, and game developers and music supervisors can easily sample, drag and drop the music modules to produce musical arrangements of any length, making the task of scoring game menus and interstitials, for example, more efficient without sacrificing music quality.

The embodiments disclosed can be used to create hundreds of different tracks, intros, loops and endings, creating versions of each with varying levels of intensity and mood. The tracks can be arranged to compliment the multitude of situations players that might be experienced. The various music modules include orchestral, dramatic, rock, electronica and rhythm & blues, hip-hop, urban, sound design, atmospheric, jazz and are appropriate for all types of audio and video editing and video games including electronic action-adventure and sports games, educational, as well as varying types of musical scoring.

The embodiments disclosed allow audio and video editors, and composers to sequence audio as easily as one might sequence images in the process of film production and editing. By combining modules of different intensity, any change in the direction or mood of the medium can have the appropriate musical accompaniment. Random programming can also be used to introduce unprecedented musical variety.

The embodiments disclosed are also applicable to preparation of commercials for television, internet, and other audiovisual media through the quantized audiovisual process. For commercials edited to music, the quantized pre-cut audiovisual timeline is especially helpful to the editor. In this case, the BPM (beats per minute) timeline is the dominant edit reference and the SMPTE (Min & Sec) timeline is not needed. This is indicative of a proven market for “Pre-Cut” tracks for which the present invention may serve as a viable and useful tool.

Additional aspects of the preferred embodiments include the ability to both clear and undo, so that previewed clip sequences may be cleared and undone. The present invention also provides several memory positions, so that favorite clip sequences may be memorized. The present invention may also include a track loaded section that provides the user with all the information about song loaded. The present invention may also be especially adapted to work with specific libraries and exploit their attributes.

In another embodiment, a stitch feature is provided to stitch together a clip sequence that has been created as described above into a single file for subsequent distribution and playback. Stitched files (and saved clip sequences) may be loaded directly from the desktop into current software.

In an embodiment, the present invention includes a time stretch feature to stretch or shrink the playback time for the user's assembled clip sequence to a precise desired duration. This feature is useful in preparing accompaniment for audio or audiovisual works with a specific time duration, or when the music needs to start and stop with a particular timing relative to some type of on-screen action in a game or visual work. The target duration may be input with any desired level of precision and may be measured in minutes, seconds, and fractions of seconds if desired. This feature may be activated by entering a desired time and clicking on a visually presented “button,” or by any other appropriate means.

In another embodiment, users can obtain access to one or more music libraries available on the internet and may selectively download clips from these libraries to use in creating musical sequences. The libraries may be provided with preview capabilities so that the user can listen to a portion of a clip or set of clips before deciding to download it.

In another embodiment, the program may be implemented on the world wide web so that users can preview and build clip sequences on the web and export the final files to their ftp sites or other online site. This feature is particularly useful in the case of large files.

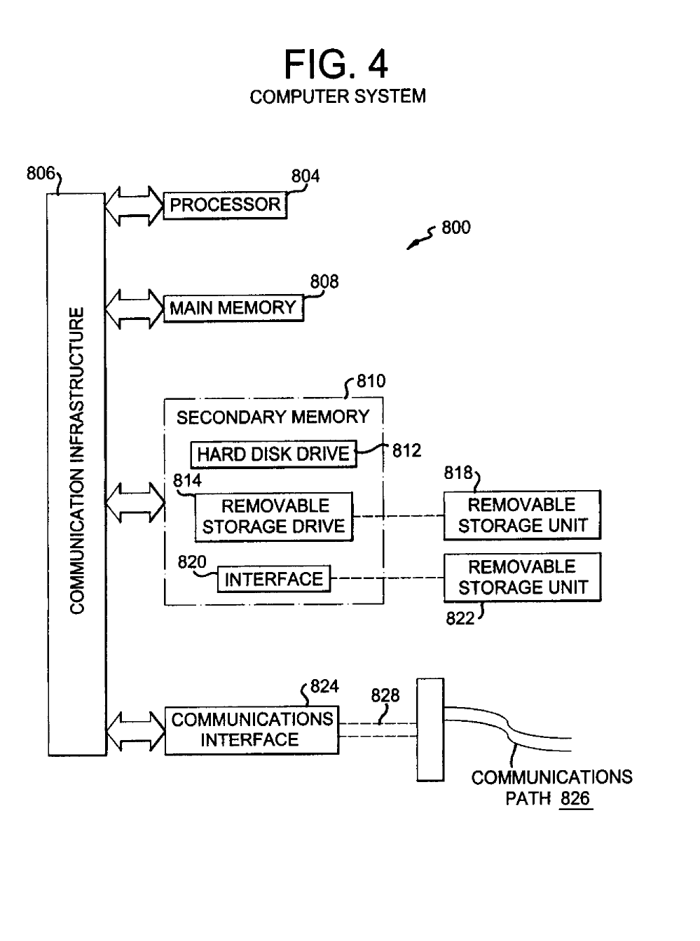

The following description of a general purpose computer system is provided for completeness. The present invention can be implemented as software, in hardware, or as a combination of software and hardware. Consequently, the invention may be implemented in the environment of a computer system or other processing system. In one exemplary embodiment, the software operating features described herein may be implemented on a personal computer or other computing system. An example of such a computer system is shown at reference number 800 in FIG. 4. In the present invention, all of the features described can execute on one or more distinct computer systems 800, to implement the various methods of the present invention. The computer system 800 includes one or more processors, such as a processor 804. The processor 804 can be a special purpose or a general purpose digital signal processor. The processor 804 is connected to a communication infrastructure 806 (for example, a bus or network). Various software implementations are described in terms of this exemplary computer system. After reading this description, it will become apparent to a person skilled in the relevant art how to implement the invention using other computer systems and/or computer architectures.

The computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well known manner. The removable storage unit 818, represents a floppy disk, magnetic tape, optical disk, etc. which is read by and written to by the removable storage drive 814. As will be appreciated, the removable storage unit 818 includes a computer usable storage medium having stored therein computer software and/or data.

In alternative implementations, the secondary memory 810 may include other similar means for allowing computer programs or other instructions to be loaded into the computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to the computer system 800.

Computer system 800 may also include a communications interface 824. Communications interface 824 allows software and data to be transferred between the computer system 800 and external devices. Examples of communications interface 824 may include a modem, a network interface (such as an Ethernet card), a communications port, a PCMCIA slot and card, or other communications path interface devices. Software and data transferred via the communications interface 824 are in the form of signals 828 which may be electronic, electromagnetic, optical or other signals capable of being received by communications interface 824. These signals 828 are provided to communications interface 824 via a communications path 826. Communications path 826 carries signals 828 and may be implemented using wire or cable, fiber optics, a phone line, a cellular phone link, an RF link and other communications channels.

In this document, the terms computer program medium and computer readable medium are used to generally refer to media such as the removable storage drive 814, a hard disk installed in hard disk drive 812, and the signals 828. These computer program products are means for providing software to the computer system 800.

Computer programs (also called computer control logic) are stored in the main memory 808 and/or the secondary memory 810. Computer programs may also be received via the communications interface 824. Such computer programs, when executed, enable the computer system 800 to implement the present invention as discussed herein. In particular, the computer programs, when executed, enable the processor 804 to implement the processes of the present invention. Accordingly, such computer programs operate to control computer system 800. By way of example, in the embodiments of the invention, the processes/methods performed by signal processing blocks of encoders and/or decoders can be performed by computer control logic. Where the invention is implemented using software, the software may be stored in a computer program product and loaded into the computer system 800 using the removable storage drive 814, the hard drive 812 communications interface 824, or any other known method of transferring digital information into a computer system.

In another embodiment, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

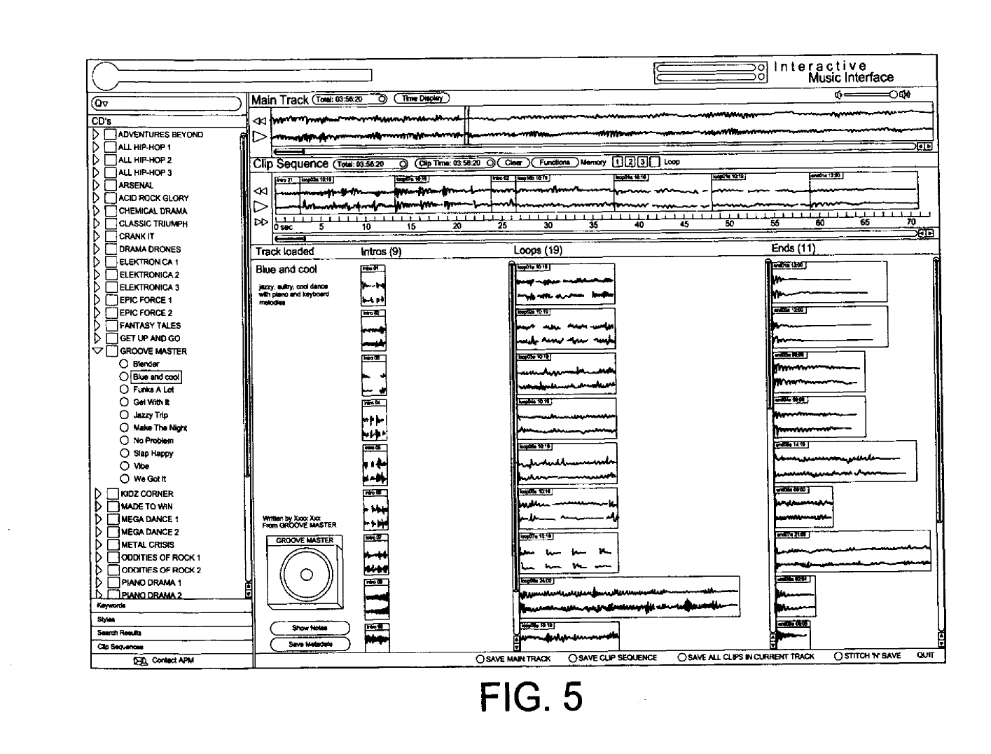

FIG. 5 shows a user interface from an implemented embodiment of the invention. The elements of the user interface shown in FIG. 5 will be understood from the description of FIGS. 1-3 above.

Another aspect of the invention is the way in which one can compose the elements (harmonics and quantized attributes) in the compositions to insure seamless transitions. These elements are sent to the composers as rules. The rules may vary on the style of music.

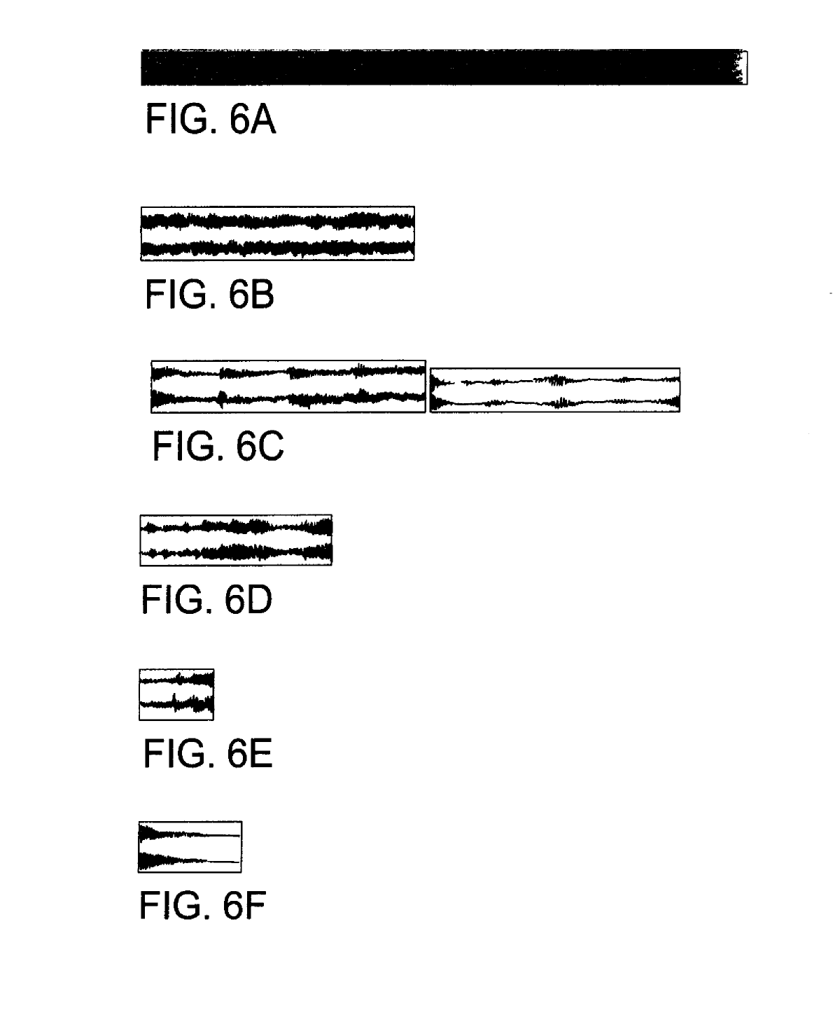

Exemplary rules for modular composition will be given with reference to FIGS. 6A-6F, in which numerical values and format specifications are illustrative rather than limiting. For example, it can be required that all tracks be delivered in stereo 44.1 kHz 24-bit AIFF files on CD or DVD. One main track, shown in FIG. 6A, is 2 minutes to 2 minutes 30 seconds in length. Loops, 15 to 20 in number, are 15 to 25 seconds in length; an example is shown in FIG. 6B.

Before mixing down a loop, one must make a copy, mix down both loops and deliver the second half; that way, any tails will be added into the beginning of the final delivered loop. When using large dynamics, one should try to start and end the loop with the loudest points. That increases the chances on either end for a smooth transition into another loop, end or intro, as shown in FIG. 6C.

Intros, five in number, are 10 to 15 seconds in length, as shown in FIG. 6D. The intros should have a hard impact at the beginning, so that they can also be used as fills, as shown in FIG. 6E.

Endings, five in number, are 10 to 15 seconds in length. All endings should be different.

Any clicks at each end of the files should be faded in and faded out. The composer should not use more than a hair to do so, or the fades will be audible.

The works need not be saved with descriptive titles. Instead, it suffices to place them into folders with names like track1_main, track1_loopl and track1_end.

Of course, other rules can be developed in addition to, or instead of, the above.

Although illustrative embodiments have been described herein in detail, it should be noted and understood that the descriptions and drawings have been provided for purposes of illustration only and that other variations both in form and detail can be added thereupon without departing from the spirit and scope of the invention. The terms and expressions have been used as terms of description and not terms of limitation. Thus, the breadth and scope of the present invention should not be limited by any of the above-described exemplary embodiments, but should be defined only in accordance with the following claims and their equivalents. The terms or expressions herein should not be interpreted to exclude any equivalents of features shown and described or portions thereof.

What is claimed is:

1. A method for allowing a user to compose music, the method comprising:
(a) displaying an interface to the user in a computing device, the interface displaying a plurality of music clips;
(b) allowing the user to select music clips from the plurality of music clips; and
(c) allowing the user to arrange the music clips into the music.

2. The method of claim 1, wherein step (a) comprises allowing the user to search the plurality of music clips by an attribute of the music clips

3. The method of claim 2, wherein the attribute is stored as metadata.

4. The method of claim 2, wherein the attribute comprises at least one of category, key word, style, known tunes and cover art.

5. The method of claim 1, wherein the plurality of music clips comprises intros, loops, and endings.

6. The method of claim 1, wherein the plurality of music clips are grouped into tracks.

7. The method of claim 1, wherein the user interface also displays a sequence of events for which the music is to be composed.

8. The method of claim 7, wherein the sequence of events comprises a timeline.

9. The method of claim 1, wherein step (c) comprises allowing the user to select alternate music clips to provide for smooth transition points among the music clips.

10. The method of claim 1, wherein the music clips are composed to provide for smooth transition points among the music clips.

11. A system for allowing a user to compose music, the system comprising:
a user interface device; and
a processing device, in communication with the user interface device, for:
(a) displaying an interface to the user, on the user interface device, the interface displaying a plurality of music clips;
(b) allowing the user to select music clips from the plurality of music clips; and
(c) allowing the user to arrange the music clips into the music.

12. The system of claim 11, wherein the processing device performs step (a) by allowing the user to search the plurality of music clips by an attribute of the music clips.

13. The system of claim 12, wherein the attribute is stored as metadata.

14. The system of claim 12, wherein the attribute comprises at least one of category, key word, style, known tunes and cover art.

15. The system of claim 11, wherein the plurality of music clips comprises intros, loops, and endings.

16. The system of claim 11, wherein the plurality of music clips are grouped into tracks.

17. The system of claim 11, wherein the user interface also displays a sequence of events for which the music is to be composed.

18. The system of claim 17, wherein the sequence of events comprises a timeline.

19. The system of claim 11, wherein the processing device performs step (c) by allowing the user to select alternate music clips to provide for smooth transition points among the music clips.

20. The system of claim 11, wherein the music clips are composed to provide for smooth transition points among the music clips.
